(19) United States
(12) Patent Application Publication
(10) Pub. No.: US 2023/0201931 A1
(43) Pub. Date: Jun. 29, 2023

(54) MACHINE TOOL AND METHOD

(71) Applicant: Klingelnberg GmbH, Huckeswagen (DE)

(72) Inventor: Matthias Daniels, Bergischen Gladbach (DE)

(21) Appl. No.: 18/087,889

(22) Filed: Dec. 23, 2022

(30) Foreign Application Priority Data
Dec. 23, 2021 (DE) 10 2021 134 593.6

(51) Int. Cl. B23B 35/00; B23Q 23/00

(52) U.S. Cl. CPC B23B 35/00; B23Q 23/00

(57) ABSTRACT

A machine tool
having a workpiece spindle,
a tool spindle,
and at least one movable machine axis configured to execute a machine kinematic to machine the workpiece using the tool.

The machine tool has a structure to be damped, and
a device for vibration damping connected to the structure for vibration damping of the structure to be damped, the device having a spring system with at least one spring element and a mass system
with at least one mass element.
wherein

The structure to be damped has a first eigenmode in a first direction,
the structure to be damped has a second eigenmode in a second direction different from the first direction, and
the spring system has first and second rigidity in first and second directions of action, respectively, with the first rigidity being greater or less than the second rigidity.

### CROSS-REFERENCE TO RELATED APPLICATIONS

This application is related to and claims the benefit of German Patent Application No. 10 2021 134 593.6, filed on Dec. 23, 2021, the contents of which are herein incorporated by reference in their entirety.

### BACKGROUND

Machine tools are used for high-accuracy manufacturing of components to be machined. Vibration excitations due to axial drives, machining forces, or the like can negatively affect the accuracy of the machining result. Using vibration dampers or vibration absorbers to reduce the vibration excitation in the range of eigenmodes of structural components of a machine tool is known.

These vibration dampers or vibration absorbers typically act one-dimensionally and therefore only damp in one spatial direction and with respect to one eigenmode. In particular for moving structures of a machine tool, this can have the result that vibration dampers or vibration absorbers which function reliably in a first position of the moving structure are inactive in a second position, since a critical excitation having deviating orientation and frequency cannot be damped for the second position. Furthermore, a structure of a machine tool, independently of its position or movement, can have various eigenmodes depending on direction, which cannot be reliably damped by a one-dimensional or symmetrically acting vibration damper or vibration absorber.

### SUMMARY

Against this background, the disclosure is based on the technical problem of specifying a machine tool and a method which enable improved vibration damping.

According to a first aspect, the disclosure relates to a machine tool, having a workpiece spindle for accommodating a workpiece, having a tool spindle for accommodating a tool, having at least one movable machine axis, wherein the machine axis is configured to execute a machine kinematic for machining the workpiece by means of the tool, having a structure to be damped, and having a device for vibration damping, which is connected to the structure to be damped for vibration damping of the structure to be damped, wherein the device for vibration damping has a spring system and a mass system, wherein the spring system has at least one spring element and wherein the mass system has at least one mass element, wherein the structure to be damped has a first eigenmode in a first direction, the structure to be damped has a second eigenmode in a second direction different from the first direction, the spring system has a first rigidity in a first direction of action, the spring system has a second rigidity in a second direction of action, and the first rigidity is greater or less than the second rigidity.

The arrangement according to the disclosure therefore in particular enables deliberate damping of various eigenmodes in two different spatial directions.

The first direction of action can be oriented in parallel to the first direction.

The second direction of action can be oriented in parallel to the second direction.

The device for vibration damping can in particular be a biaxially acting device for vibration damping, which is configured to damp two eigenmodes of the structure to be damped simultaneously, which have deformation components oriented orthogonally to one another, for example, upon excitation, wherein the first direction extends along a direction of a first deformation component of the orthogonally oriented deformation components and the second direction extends along a direction of the second deformation component of the orthogonally oriented deformation components.

When the biaxially acting device for vibration damping is mounted, for example, on a moving part of the structure to be damped, in particular a correction of the directions of action of the biaxially acting device can be carried out for vibration damping. To reduce externally-excited vibrations, moreover a deliberate alignment of the directions of action can be carried out on the basis of the force vectors acting on the structure to be damped.

The biaxially acting device for vibration damping can be a vibration absorber.

The vibration absorber can consist of the spring system and the mass system.

The biaxially acting device for vibration damping can be a vibration damper, wherein the vibration damper can have, in addition to the spring system and the mass system, a damper system having one or more active dampers and/or one or more passive dampers.

It can be provided that at least one spring element is bar-shaped and has a double-symmetrical cross section, such as a rectangular cross section, an elliptical cross section, or the like.

At least one spring element can be bar-shaped and can have axial geometrical moments of inertia which are different in their absolute value with respect to the first direction of action and the second direction of action.

A positioning device can be provided, wherein the positioning device can be configured to set a relative position and/or orientation of the spring element relative to the structure to be damped. In this way, directions of action of the device for vibration damping can be set in dependence on the installation situation and/or the operating loads to be expected. The setting can take place automatically and/or manually.

The positioning device can be assigned a drive for executing positioning movements of the positioning device.

The positioning device can be lockable to fix the relative position and/or orientation. In particular, the positioning device can be lockable on the structure to be damped.

The device for vibration damping can have a damper system having at least one damping element, wherein the damper system can in particular have an active and/or a passive damping element.

The mass system can have precisely one mass element or can consist of precisely one mass element.

The mass system can have at least one mass element, which has a main body for accommodating and/or fastening further mass elements, wherein at least one of the further mass elements is arranged in a recess of the main body and/or at least one of the further mass elements is detachably connected to the main body, in particular is screwed or pinned thereon.

At least one mass element can include a steel material or can consist of a steel material.

At least one recess can be part of a damper system with a mass element accommodated therein, wherein an oil for squeeze film damping is provided in the receptacle. Alternatively or additionally, the damper system can have passive dampers, such as rubber cushions or the like, or can have active or passive pneumatic or hydraulic dampers.

The first direction of action and the second direction of action can be arranged orthogonally to one another. A longitudinal extension of the spring element can be oriented orthogonally to the first direction of action and to the second direction of action.

The first direction and the second direction can be arranged orthogonally to one another. A longitudinal extension of the spring element can be oriented orthogonally to the first and to the second direction.

The spring system can have two or more spring elements. The spring system can in particular have precisely four spring elements.

A spring element can be a bolt.

The spring element can comprise a steel material or consist of a steel material.

At least two spring elements can have a spacing from one another.

At least two spring elements can be arranged abutting one another and can form a spring element packet, wherein the spring elements of the spring element packet can in particular be connected to one another.

A positioning device can be assigned to each spring element. The spring element is therefore individually adjustable in this case.

A positioning device can be assigned to two or more spring elements. The two or more spring elements are adjustable jointly by the assigned positioning device in this case.

All spring elements can be assigned to a single positioning device. All spring elements are jointly adjustable by a single positioning device in this case.

The structure to be damped can be a movable part of the machine axis and the device for vibration damping can be arranged on the movable part of the machine axis and can be movable with this movable part of the machine axis. The damping of a movable structure of the machine tool can thus be improved.

The structure to be damped can be a tool spindle axis having the tool spindle, wherein the tool spindle is movable and/or pivotable by means of the tool spindle axis.

The device for vibration damping can have a controllable, active damper, wherein the orientation of the first direction of action relative to the structure to be damped and/or the orientation of the second direction of action relative to the structure to be damped and/or the first rigidity and/or the second rigidity are controllable in dependence on operating loads acting on the structure to be damped.

According to a second aspect, the disclosure relates to a method, having the following method steps: providing a machine tool according to the disclosure, machining a workpiece accommodated on the workpiece spindle by means of a rotationally-driven tool accommodated on the tool spindle, wherein the machine axis executes a machine kinematic for machining the workpiece by means of the tool and wherein the device for vibration damping causes damping of a vibration along the first direction and/or the second direction.

### BRIEF DESCRIPTION OF THE DRAWINGS

The disclosure is described in more detail hereinafter with reference to a drawing illustrating exemplary embodiments. In the schematic figures:

FIG. 1 shows a machine tool according to the disclosure;

FIG. 2A shows a first device for vibration damping in a side view;

FIG. 2B shows the first device for vibration damping in a further side view;

FIG. 2C shows the first device for vibration damping in a section II-C-II-C according to FIG. 2B;

FIG. 3A shows a second device for vibration damping in a side view;

FIG. 3B shows the second device for vibration damping in a further side view;

FIG. 3C shows the second device for vibration damping in a section III-C-III-C according to FIG. 3B;

FIG. 4A shows a third device for vibration damping in a cross section;

FIG. 4B shows a fourth device for vibration damping in a cross section;

FIG. 4C shows a fifth device for vibration damping in a cross section;

FIG. 5A shows a sixth device for vibration damping in a side view having positioning device;

FIG. 5B shows the sixth device for vibration damping in a section V-B-V-B according to FIG. 5A in a first adjustment position;

FIG. 5C shows the sixth device for vibration damping in a section V-B-V-B according to FIG. 5A in a second adjustment position;

FIG. 6A shows a seventh device for vibration damping in a side view having positioning devices;

FIG. 6B shows the seventh device for vibration damping in a section VI-B-VI-B according to FIG. 6A in a first adjustment position;

FIG. 6C shows the seventh device for vibration damping in a section VI-B-VI-B according to FIG. 6A in a second adjustment position;

FIG. 7 shows an eighth device for vibration damping;

FIG. 8A shows a ninth device for vibration damping;

FIG. 8B shows a tenth device for vibration damping.

### DETAILED DESCRIPTION OF THE DRAWINGS

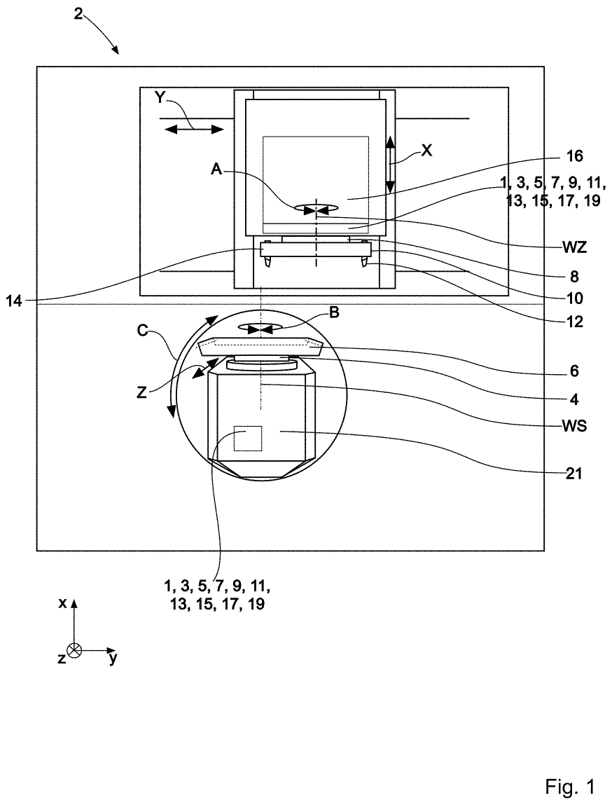

FIG. 1 shows a machine tool 2. The machine tool 2 is a gear cutting machine for bevel gear production.

The machine tool 2 has a workpiece spindle 4 for accommodating a workpiece 6. The machine tool 2 has a tool spindle 8 for accommodating and rotationally driving a tool 10.

In the figures, a Cartesian coordinate system having the directions x, y, and z is used.

The machine tool 2 is a 6-axis machine and has six CNC-controlled machine axes —specifically a linear axis X, a linear axis Y, a linear axis Z, wherein X, Y, and Z are each arranged orthogonally to one another, a workpiece axis of rotation B for workpiece rotation around a workpiece axis WS, a tool axis of rotation A for rotationally driving the tool 10 around a tool axis WZ, and a workpiece pivot axis C for pivoting the workpiece 6. The machine axes are configured to execute a machine kinematic to machine the workpiece 6 by means of the tool 10 and have, for example, direct drives, ball screw drives, or the like in order to execute the relative movements between tool 10 and workpiece 6.

The tool 10 is a bar cutterhead 10, which has exchangeable bar cutters 12. The bar cutters 12 are detachably held on a main body 14 of the bar cutterhead 10. The bar cutterhead 10 is provided for dry milling of the workpiece 6.

The tool spindle 8 is held and mounted on an axial housing 16 of the machine tool 2. The axial housing 16 is in the present case a structure 16 to be damped of the machine tool 8.

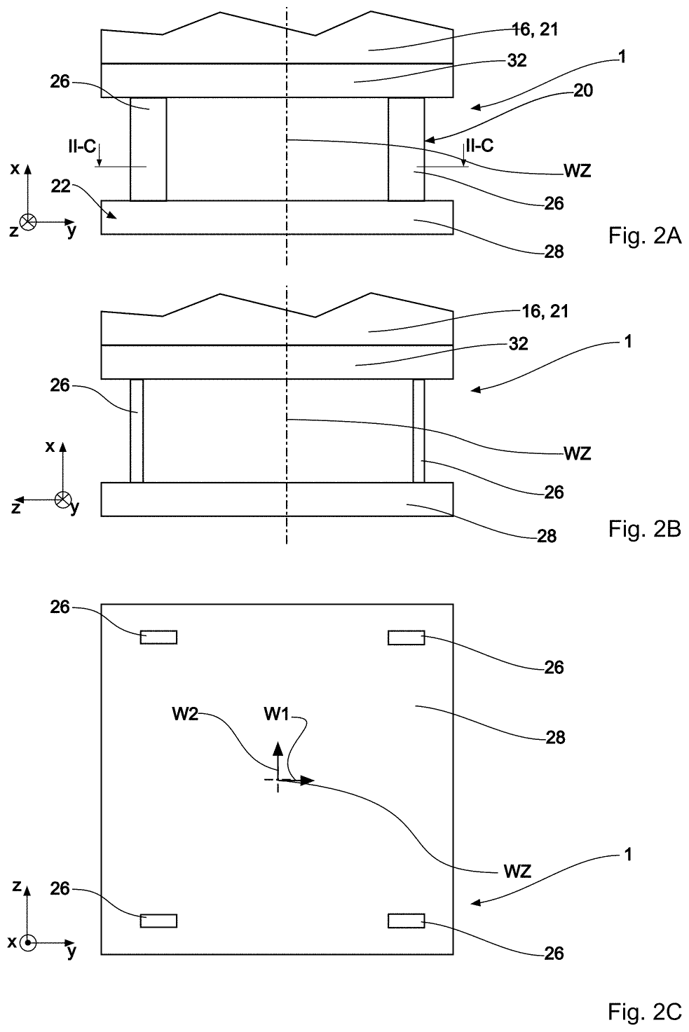

A device for vibration damping 1, 3, 5, 7, 9, 11, 13, 15, 17, 19 of the machine tool 2 is connected to the structure 16 to be damped for vibration damping of the structure 16 to be damped. The device for vibration damping 1, 3, 5, 7, 9, 11, 13, 15, 17, 19 can be a vibration absorber or a vibration damper. Different variants of devices 1, 3, 5, 7, 9, 11, 13, 15, 17, 19 for vibration damping are shown in FIGS. 2-8.

According to FIG. 1, alternatively or additionally, a device for vibration damping 1, 3, 5, 7, 9, 11, 13, 15, 17, 19 can be assigned to a structure 21 to be damped. One or more devices for vibration damping 1, 3, 5, 7, 9, 11, 13, 15, 17, 19 can be arranged as needed on fixed or moving structures of the gear cutting machine 2, in order to damp vibrations in operation of the gear cutting machine 2. A structure 16, 21 to be damped can therefore be assigned a single one or several of the devices for vibration damping 1, 3, 5, 7, 9, 11, 13, 15, 17, 19 described hereinafter with reference to FIGS. 2-8. Depending on the absolute value and direction of the eigenmodes to be damped, a device for vibration damping 1, 3, 5, 7, 9, 11, 13, 15, 17, 19 designed as a vibration damper or as vibration absorber can be used for the vibration damping.

Both the structure 16 to be damped and also the structure 21 to be damped are a movable part of the respective associated machine axis and the devices for vibration damping 1, 3, 5, 7, 9, 11, 13, 15, 17, 19, are arranged on the respective movable part 16, 21 of the relevant machine axis and are movable together with this movable part of the machine axis.

A device for vibration damping 1, 3, 5, 7, 9, 11, 13, 15, 17, 19 can, instead of the arrangement shown here below the axial housing 16, be seated according to alternative embodiments above the axial housing 16 on the axial housing 16.

FIGS. 2A-2C show a first device for vibration damping 1. The device for vibration damping 1 has a spring system 20 and a mass system 22. The device for vibration damping 1 is a vibration absorber 1 in the present example.

The spring system 20 has four spring elements 26 in the present case.

The mass system 22 has one mass element 28 in the present case.

A structure 16, 21 to be damped by means of the device for vibration damping 1 can have, for example, a first eigenmode in the y direction. A structure 16, 21 to be damped by means of the device for vibration damping 1 can have, for example, a second eigenmode in the z direction. A corresponding excitation in the y direction would result in a deformation component in the y direction. A corresponding excitation in the z direction would result in a deformation component in the z direction.

The spring system 20 has a first rigidity in a first direction of action W1. The spring system 20 has a second rigidity in a second direction of action W2. The first rigidity is greater than the second rigidity.

The spring elements 26 are bar-shaped and each have a double-symmetrical cross section, in the present case a rectangular cross section (FIG. 2C). The spring elements 26 are bar-shaped and have axial geometrical moments of inertia differing in their absolute value with respect to the y direction and the z direction. Bar-shaped means here that the longitudinal extension of a respective spring element 26 measured in the x direction is greater than twice the respective transverse extension in the y direction and the z direction measured orthogonally thereto.

The first direction of action W1 and the second direction of action W2 are arranged orthogonally to one another and the longitudinal extension of the spring elements 26 is oriented orthogonally to the first direction of action W1 and the second direction of action W2. The y direction and the z direction are arranged orthogonally to one another and the longitudinal extension of the spring elements 26 is oriented orthogonally to the y direction and the z direction. The first direction of action W1 is oriented in parallel to the y direction. The second direction of action W2 is oriented in parallel to the z direction.

All spring elements 26 are arranged spaced apart from one another in the present case.

The spring elements 26 consist of a steel material. The mass element 28 consists of a steel material.

The spring elements 26 are held on a connecting element 32. The connecting element 32 is connected to the structure 16, 21 to be damped.

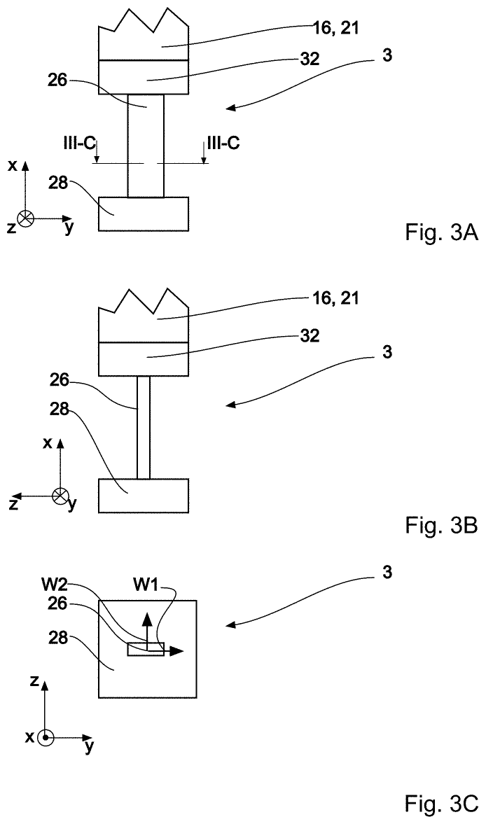

FIGS. 3A-3C show a second device for vibration damping 3. The device for vibration damping 3 is assigned to a structure 16′, 21 to be damped of the machine tool 2. The device for vibration damping 3 is connected by means of a connecting element 32 to the structure 16′ to be damped of the machine tool 2. The device for vibration damping 3 has a single spring element 26 and a mass element 28. The device for vibration damping 3 has a direction-dependent rigidity and thus direction-dependent damping properties due to the rectangular cross section of the spring element 26.

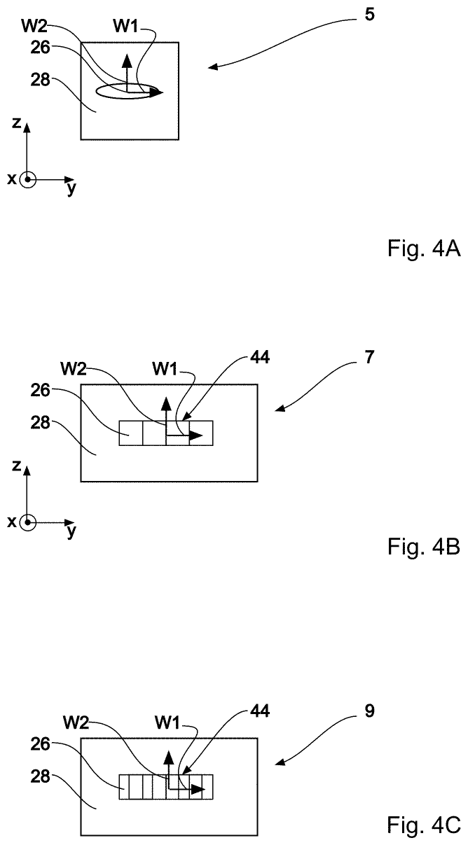

FIG. 4A shows a third device for vibration damping 5, the spring element 26 of which has an elliptical cross section, having a mass element 5.

FIG. 4B shows a fourth device for vibration damping 7, the spring elements 26 of which have a square cross section, having a mass element 28, wherein the spring elements 26 are arrayed and densely packed in the direction of action W1.

FIG. 4C shows a fifth device for vibration damping 9, the spring elements 26 of which have a rectangular cross section, having a mass element 28, wherein the spring elements 26 are arrayed and densely packed in the direction of action W1.

The spring elements 26 according to FIGS. 4B and 4C each form spring element packets 44.

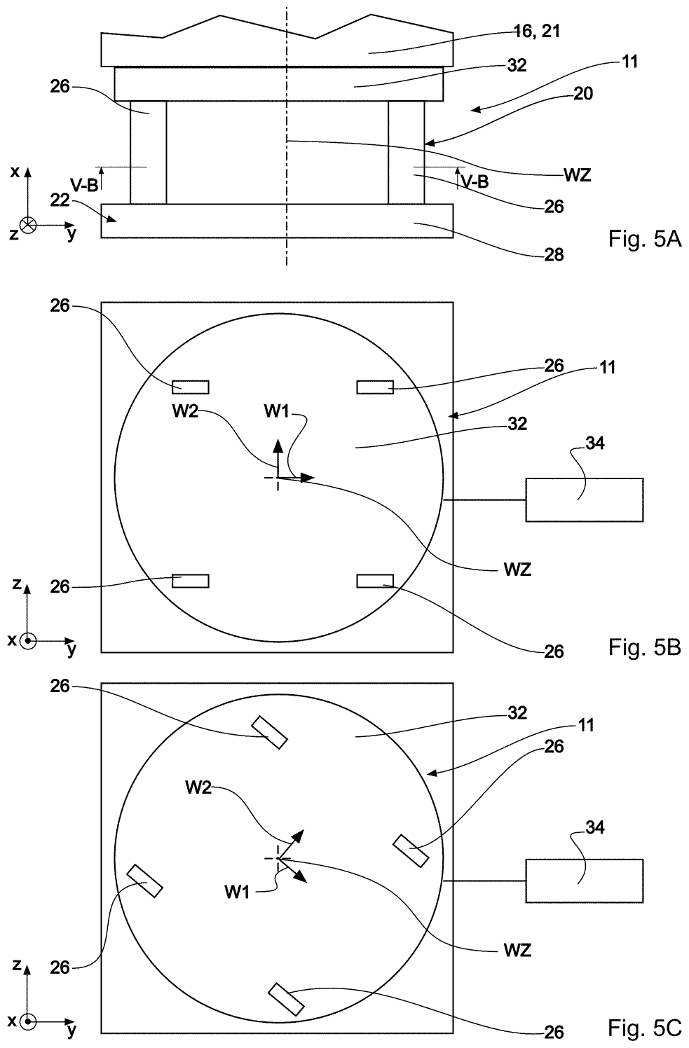

The spring elements 26 described with reference to FIGS. 2 and 3 and with reference to FIGS. 5-8 can, according to alternative exemplary embodiments, have the cross-sectional shapes and/or arrangements shown in FIG. 4A-FIG. 4C.

FIGS. 5A-5C show a sixth device for vibration damping 11. The connecting element 32 of the device for vibration damping 11 can at the same time be a positioning device 32 (FIG. 5A-FIG. 5C), wherein the positioning device 32 is configured to set a relative position and/or orientation of the spring elements 26 relative to the structure 16, 21 to be damped. As shown in FIG. 5C, the spring elements 26 together with the mass element 28 held thereon can be pivoted around the x axis, so that the directions of action W1 and W2 change in their orientation, and so that the rigidity and the damping properties can be adapted in the z and y directions. The positioning device 32 is lockable to fix the relative orientation on the structure 16, 21 to be damped.

A drive 34 for executing positioning movements of the positioning device 32 is assigned to the positioning device 32.

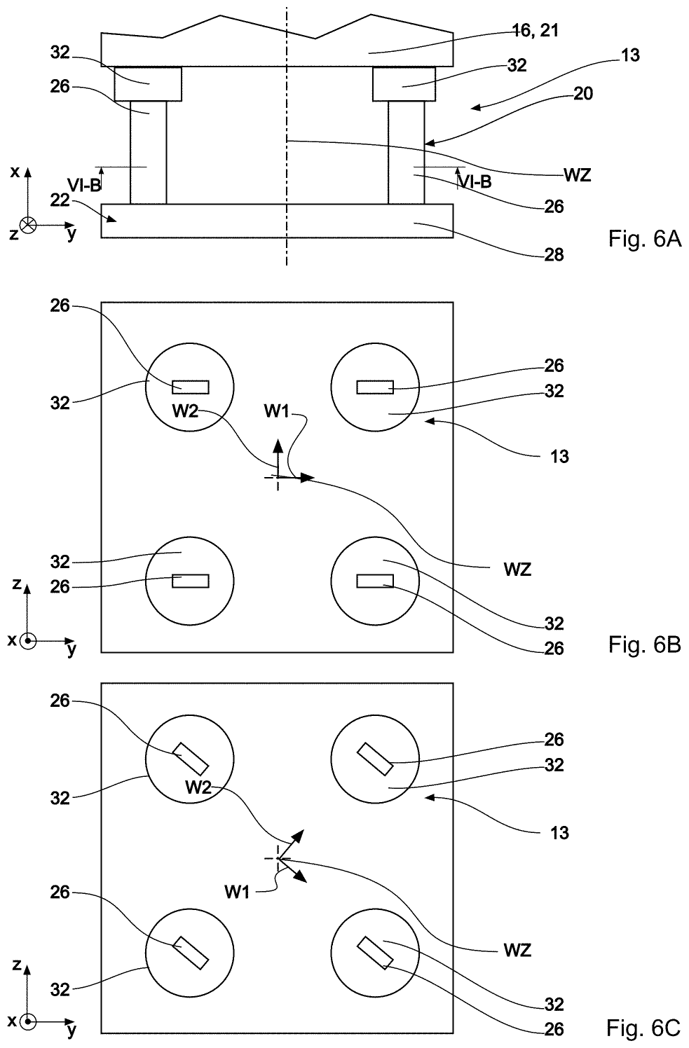

FIGS. 6A-6C show a seventh device for vibration damping 13. A separate positioning device 32 can be assigned to each spring element 26 according to the variant according to FIGS. 6A-6C, so that the spring elements 26 can be adjustable individually, i.e., separately and independently of one another.

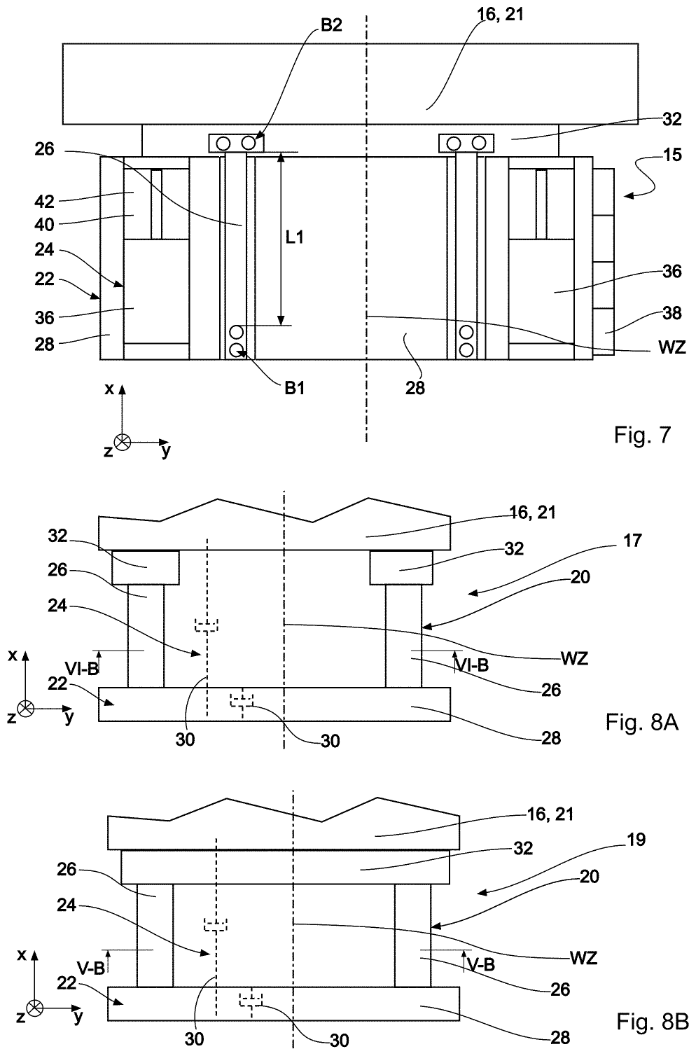

FIG. 7 shows an eighth device for vibration damping 15. The spring elements 26 are bolts 26 having rectangular cross section here. Each bolt 26 has a free length Ll, which extends between fastening points B1 and B2 of the relevant bolt 26. A respective bolt 26 is connected to the mass system 22 by the fastening point B1. A respective bolt 26 is connected to the connecting element 32 by the fastening point B2. The bolts 26 are steel bolts.

The mass system 22 has a main body 28 or a mass element 28 for accommodating and fastening further mass elements 36, 38. The further mass elements 36 are arranged movably in a respectively assigned recess 40 of the main body 28, wherein the respective recess 40 is filled with an oil to effectuate a squeeze film damping. The further mass elements 36 are part of a damper system 24.

The further mass elements 38 are detachably connected to the main body 28 for fine adjustment of the mass of the mass system 22.

FIG. 8A shows a ninth device for vibration damping 17. The device for vibration damping 15 essentially corresponds to the device for vibration damping 13, wherein the device for vibration damping 15 additionally has a damper system 24 having damper elements 30.

FIG. 8B shows a tenth device for vibration damping 19. The device for vibration damping 19 essentially corresponds to the device for vibration damping 11, wherein the device for vibration damping 19 additionally has a damper system 24 having damper elements 30.

Each device for vibration damping 1, 3, 5, 7, 9, 11, 13, 15 can, according to alternative exemplary embodiments, also be assigned a damper system 24 having one or more damper elements 30.

Each mass element 28 of a device for vibration damping 1, 3, 5, 7, 9, 11, 13, 17, 19 can, according to alternative exemplary embodiments, be assigned to further mass elements 36, 38, analogously to the device for vibration damping 15. The various features of the exemplary embodiments are therefore combinable with one another.

1. A machine tool comprising:
a workpiece spindle (4) for accommodating a workpiece (6),
a tool spindle (8) for accommodating a tool (10),
at least one movable machine axis (A, B, C, X, Y, Z), wherein the machine axis (A, B, C, X, Y, Z) is configured to execute a machine kinematic to machine the workpiece (6) using the tool (10),
a structure (16, 21) to be damped, and
a device for vibration damping (1, 3, 5, 7, 9, 11, 13, 15, 17, 19), which is connected to the structure (16, 21) to be damped for vibration damping of the structure (16, 16′) to be damped, wherein the device for vibration damping (1, 3, 5, 7, 9, 11, 13, 15, 17, 19) has a spring system (20) and a mass system (22),
wherein the spring system (20) has at least one spring element (26), and
wherein the mass system (22) has at least one mass element (28, 36, 38),
wherein
the structure (16, 21) to be damped has a first eigenmode in a first direction (y),
the structure to be damped has a second eigenmode in a second direction (z) different from the first direction (y),
the spring system (20) has a first rigidity in a first direction of action (W1), the spring system (20) has a second rigidity in a second direction of action (W2), and the first rigidity is greater or less than the second rigidity.

2. The machine tool according to claim 1,
wherein
the first direction of action (W1) is oriented in parallel to the first direction (y) and/or
the second direction of action (W2) is oriented in parallel to the second direction (z).

3. The machine tool according to claim 1, wherein
at least one spring element (26) is bar-shaped and has a double-symmetrical cross section, and/or
at least one spring element (26) is bar-shaped and has axial geometrical moments of inertia differing in their absolute value with respect to the first direction of action (W1) and the second direction of action (W2).

4. The machine tool according to claim 1,
wherein
a positioning device (32) is provided,
wherein the positioning device (32) is configured to set a relative position and/or orientation of the spring element (26) relative to the structure (16, 21) to be damped.

5. The machine tool according to claim 4,
wherein
a drive (34) for executing positioning movements of the positioning device (32) is assigned to the positioning device (32) and/or
the positioning device (32) is lockable to fix the relative position and/or orientation.

6. The machine tool according to claim 1,
wherein
the device for vibration damping (1, 3, 5, 7, 9, 11, 13, 15, 17, 19) has a damper system (24) having at least one damping element (30), and
wherein the damper system (24) has an active and/or a passive damping element (30).

7. The machine tool according to claim 1,
wherein
the mass system (22) has at least one mass element (28), which has a main body (28) for accommodating and/or fastening further mass elements (36, 38),
wherein at least one of the further mass elements (36) is arranged in a recess (40) of the main body (20) and/or at least one of the further mass elements (38) is detachably connected to the main body.

8. The machine tool according to claim 6, wherein
at least one recess (40) having a mass element (36) accommodated therein is part of the damper system (24), wherein an oil (42) for squeeze film damping is provided in the recess (40).

9. The machine tool according to claim 1,
wherein
the first direction of action (W1) and the second direction of action (W1) are arranged orthogonally to one another
and/or
the first direction (y) and the second direction (z) are arranged orthogonally to one another
and/or
a longitudinal extension of the spring element (26) is oriented orthogonally to the first direction of action (W1) and to the second direction of action (W1).

10. The machine tool according to claim 1,
wherein
the spring system (20) has two or more spring elements (26).

11. The machine tool according to claim 9,
wherein
at least two spring elements (26) have a spacing from one another and/or
at least two spring elements (26) are arranged abutting one another and form a spring element packet (44), wherein the spring elements (26) of the spring element packet (44) are connected to one another.

12. The machine tool according to one of claim 5,
wherein
a positioning device (32) is assigned to each spring element (26),
two or more spring elements (26) are assigned to one positioning device (32), or
all spring elements (26) are assigned to a single positioning device (32).

13. The machine tool according to claim 1,
wherein
the structure (16, 16′) to be damped is a movable part of the machine axis (A, B, C, X, Y, Z) and
the device for vibration damping (1, 3, 5, 7, 9, 11, 13, 15, 17, 19) is arranged on the movable part of the machine axis (A, B, C, X, Y, Z) and is movable with this movable part of the machine axis (A, B, C, X, Y, Z).

14. The machine tool according to claim 1,
wherein
the structure to be damped is a tool spindle axis having the tool spindle,
wherein the tool spindle is movable and/or pivotable using the tool spindle axis.

15. The machine tool according to claim 1,
wherein
the device for vibration damping (1, 3, 5, 7, 9, 11, 13, 15, 17, 19) has a controllable, active damper,
wherein the orientation of the first direction of action (W1) relative to the structure to be damped and/or the orientation of the second direction of action (W2) relative to the structure (16, 16′) to be damped and/or the first rigidity and/or the second rigidity are controllable in dependence on operating loads acting on the structure (16, 16′) to be damped.

16. A method, having the following method steps:
providing a machine tool (2) according to claim 1; and
machining a workpiece (6) accommodated on the workpiece spindle (4) by a rotationally driven tool (10) accommodated on the tool spindle (8),
wherein the machine axis (A, B, C, X, Y, Z) executes a machine kinematic to machine the workpiece (6) using the tool (10) and
wherein the device for vibration damping (1, 3, 5, 7, 9, 11, 13, 15, 17, 19) effectuates damping of a vibration along the first direction (y) and/or the second direction (z).
